(19) United States
(12) Patent Application Publication
(10) Pub. No.: US 2015/0169811 A1
(43) Pub. Date: Jun. 18, 2015

(54) SYSTEM AND METHOD FOR ESTIMATION AND CONTROL OF CLEARANCE IN A TURBO MACHINE

(71) Applicant: General Electric Company, Schenectady, NY (US)

(72) Inventors: Norman Arnold Turnquist, Carlisle, NY (US); Changjie Sun, Clifton Park, NY (US); Deepak Trivedi, Schenectady, NY (US); Jaydeep Roy, Northborough, MA (US); Emad Andarawis Andarawis, Ballston Lake, NY (US); Murat Inalpolat, Clifton Park, NY (US); Arun Karthi Subramaniyan, Clifton Park, NY (US); Fernando Javier D'Amato, Niskayuna, NY (US); Emrah Biyik, Izmir (TR)

(73) Assignee: General Electric Company, Schenectady, NY (US)

(21) Appl. No.: 14/132,313

(22) Filed: Dec. 18, 2013

(51) Int. Cl. G06F 17/50

(52) U.S. Cl. CPC G06F 17/5018

(57) ABSTRACT

A method implemented using at least one processor includes receiving a plurality of measured operational parameters of a turbo machine having a rotor and a stator. The plurality of measured operational parameters includes a plurality of real-time operational parameters and a plurality of stored operational parameters. The method further includes generating a finite element model of the turbo machine and generating a plurality of snapshots based on the finite element model and the plurality of stored operational parameters. The method further includes generating a reduced order model based on the plurality of snapshots. The method also includes determining an estimated clearance between the rotor and the stator during operation of the turbo machine, based on the reduced order model and the plurality of real-time operational parameters.

### BACKGROUND

The subject matter disclosed herein relates generally to clearance control in a turbo machine. More specifically, the subject matter relate to methods and systems for estimation and control of clearance in a turbo machine, using a reduced order model.

Minimizing clearance between blade tips of a rotor and stationary parts in a turbo machine is desirable to reduce leakage of a working fluid around the blade tips. In a centrifugal compressor, an abradable coating deposited on a shroud surface, provides a reduced clearance customized to the particular blade/shroud arrangement. A coating which is abraded due to blade contact, may not be suitable for some turbo machine applications, where a smooth shroud surface is desired. Further, rough and uneven surfaces associated with the abradable coating often adversely impact the machine performance.

Losses due to blade tip clearance results in lower efficiency and higher fuel consumption. During the operating life of the machine, blade tip clearance increases over time due to mechanical rubs between the rotating blades and the stationary casing, thereby affecting performance of the machine.

It is sometimes desirable to dynamically change clearance during operation of the machine. Several existing blade tip clearance adjustment mechanisms include complicated linkages and contribute to significant weight and/or require a considerable amount of power for operation of the machine.

An enhanced system and method for estimation and control of a blade tip clearance in rotating machines, are desirable.

### BRIEF DESCRIPTION

In accordance with one exemplary embodiment, a method is disclosed. The method includes receiving a plurality of measured operational parameters of a turbo machine having a rotor and a stator. The plurality of measured operational parameters includes a plurality of real-time operational parameters and a plurality of stored operational parameters. The method further includes generating a finite element model of the turbo machine and generating a plurality of snapshots based on the finite element model and the plurality of stored operational parameters. The method further includes generating a reduced order model based on the plurality of snapshots. The method also includes determining an estimated clearance between the rotor and the stator during operation of the turbo machine, based on the reduced order model and the plurality of real-time operational parameters.

In accordance with another embodiment, a system is disclosed. The system includes at least one processor configured to receive a plurality of measured operational parameters of a turbo machine having a rotor and a stator. The plurality of measured operational parameters includes a plurality of real-time operational parameters and a plurality of stored operational parameters. The system further includes a finite element module communicatively coupled to the at least one processor and configured to generate a finite element model of the turbo machine. The finite element module is configured to generate a plurality of snapshots based on the finite element model and the plurality of stored operational parameters. The system further includes a model builder communicatively coupled to the finite-element module and configured to generate a reduced order model based on the plurality of snapshots. The system also includes a clearance controller communicatively coupled to the model builder and configured to determine an estimated clearance between the rotor and the stator during operation of the turbo machine, based on the reduced order model and the plurality of real-time operational parameters.

In accordance with another aspect of the present technique, a non-transitory encoded computer medium having instructions to enable at least one processor is disclosed. The instructions enable the at least one processor to receive a plurality of measured operational parameters of a turbo machine having a rotor and a stator. The plurality of measured operational parameters includes a plurality of real-time operational parameters and a plurality of stored operational parameters. The instructions further enable the at least one processor to generate a finite element model of the turbo machine and generate a plurality of snapshots based on the finite element model and the plurality of stored operational parameters. The instructions further enable the at least one processor to generate a reduced order model based on the plurality of snapshots. The instructions also enable the at least one processor to determine an estimated clearance between the rotor and the stator during operation of the turbo machine, based on the reduced order model and the plurality of real-time operational parameters.

### DRAWINGS

These and other features and aspects of embodiments of the present invention will become better understood when the following detailed description is read with reference to the accompanying drawings in which like characters represent like parts throughout the drawings, wherein:

FIG. 1 is a schematic block diagram of an active clearance control system in accordance with an exemplary embodiment;

FIG. 2 is a flow diagram illustrating a method for estimation and control of clearance in accordance with an exemplary embodiment;

FIG. 3 is a graph illustrating an axial clearance profile in accordance with an exemplary embodiment;

FIG. 4 is a graph illustrating a radial clearance profile in accordance with an exemplary embodiment; and

FIG. 5 illustrates a flow chart showing a method for estimating a clearance, based a reduced order model, in accordance with an exemplary embodiment.

### DETAILED DESCRIPTION

Embodiments of the present invention relate to a system and a method for estimation and control of clearance in a turbo machine. Specifically, in certain embodiments, a method involves receiving a plurality of measured operational parameters of a turbo machine having a rotor and a stator. The plurality of measured operational parameters includes a plurality of real-time operational parameters and a plurality of stored operational parameters. A finite element model of the turbo machine is generated and a plurality of snapshots are generated based on the finite element model and the plurality of stored operational parameters. A reduced order model is generated based on the plurality of snapshots. An estimated clearance between the rotor and the stator is determined based on the reduced order model and the plurality of real-time operational parameters. A measured clearance between the rotor and the stator is controlled based on the estimated clearance.

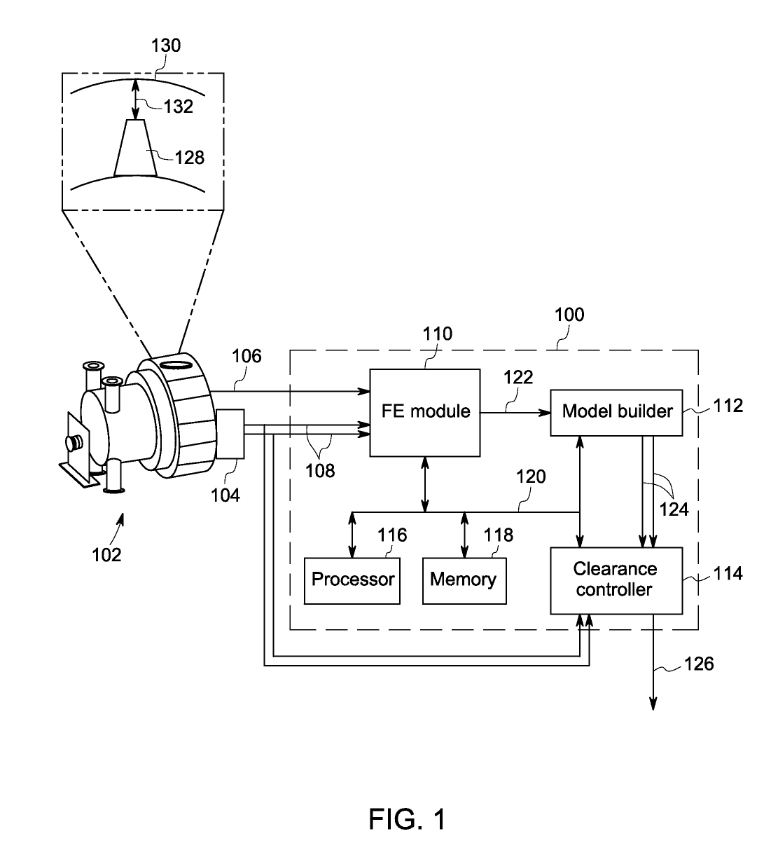

FIG. 1 is a schematic block diagram of an active clearance control system 100 in accordance with an exemplary embodiment. The system 100 is used to determine an estimated clearance 126 and control a measured clearance 132 between a rotor 128 and a stator 130 of a turbo machine 102 based on the estimated clearance 126. The system 100 includes a finite element module 110, a model builder 112, a clearance controller 114, at least one processor 116, and a memory 118, coupled to a communication bus 120.

In the illustrated embodiment, a sensor module 104 having a plurality of sensors is used to acquire a plurality of measured operational parameters 108 of the turbo machine 102. The plurality of measured operational parameters 108 includes a plurality of real-time operational parameters and a plurality of stored operational parameters. The plurality of real-time operational parameters refers to the plurality of measured operational parameters received during operation of the turbo machine in real time. The plurality of stored operational parameters refers to the plurality of measured operational parameters generated previously and stored for future requirements. The system 100 receives the plurality of measured operational parameters 108 and a plurality of turbo machine design parameters 106 of the turbo machine 102 and determines the estimated clearance 126 between the rotor 128 and the stator 130. The sensor module 104 may include a plurality of sensors including a pressure sensor, a temperature sensor, a mass flow sensor, and a displacement sensor for measuring an inlet pressure of a working fluid, an inlet temperature of the working fluid, an exhaust temperature, a mass flow of the working fluid, and the displacement of the rotor 128. In one embodiment, the measured clearance 132 is an axial clearance between the rotor 128 and the stator 130 in the turbo machine 102. In another embodiment, the measured clearance 132 is a radial clearance between the rotor 128 and the stator 130 in the turbo machine 102.

The turbo machine 102 exhibits a plurality of operating conditions during an operational cycle. In one embodiment, the operating condition is a long rotor condition. The long rotor condition is a transient operating condition of the turbo machine 102 in which the turbo machine 102 undergoes transition from a shut-down condition to a steady state condition. During the long rotor condition, the rotor 128 of the turbo machine 102 expands thermally along an axial direction and along a radial direction resulting in a shell growth (also referred to as ‘case expansion’). In another embodiment, the operating condition is a short rotor condition. The short rotor condition is a transient operating condition of the turbo machine 102 in which the turbo machine 102 undergoes transition from the steady state condition to the shut-down condition. During the short rotor condition, an outer casing of the machine 102 undergoes thermal contraction. The duration of thermal contraction of the outer casing is relatively faster compared to the duration of thermal contraction of the rotor 128 of the turbo machine 102.

The finite element module 110 is communicatively coupled to the sensor module 104 and configured to receive the plurality of measured operational parameters 108 of the turbo machine 102. In an exemplary embodiment, the finite element module 110 is configured to receive the turbo machine design parameters 106 and generate a finite element model for the turbo machine 102 based on the turbo machine design parameters 106 and the stored operational parameters. In one embodiment, the finite element module 110 is configured using software to receive design parameters and measured operational parameters 106, 108. In another embodiment, the finite element module 110 is configured to receive design parameters and measured operational parameters 106, 108 via at least one input port. In one embodiment, the design parameters 106 may be a CAD design of the turbo machine 102. In another embodiment, the design parameters 106 may be wholly or partly specified by a user. The finite element model of the turbo machine 102 includes a mesh having a plurality of elements represented by node coordinates coupled to each other via elemental connectors. Such a mesh may be generated by any suitable commercial finite element software packages such as ANSYS®, an open source finite element software package such as OOFEM, or the like. The details of the finite element model are explained in greater detail with reference to subsequent figures.

The finite element module 110 is configured to solve a plurality of finite element equations to generate a displacement vector and a plurality of nodal temperatures. Further, the finite element module 110 generates a plurality of snapshots 122 based on the finite element model and the plurality of stored operational parameters. The term “snapshot” is referred to herein as an operating condition of the turbo machine 102 determined based on the plurality of stored operational parameters and the displacement vector generated by the finite element model. In an alternate embodiment, the snapshot 122 may include a plurality of nodal temperature values generated by the finite element module 110. In one embodiment, the finite element module 110 is a software module stored in the memory 118 and executable by the at least one processor 116. In an alternate embodiment, the finite element module 110 is a specialized hardware module configured to generate the plurality of snapshots 122.

The model builder 112 is communicatively coupled to the finite element module 110. The model builder 112 is configured to receive the plurality of snapshots 122 and generate a reduced order model 124. In one embodiment, the model builder 112 is configured using a software to receive the reduced order model 122. In another embodiment, the model builder 112 is configured to receive the reduced order model 122 via an input port. In one embodiment, the model builder 112 is configured to generate the reduced order model 124 based on an orthogonal decomposition technique. In one example, the model builder 112 generates the reduced order model 124 having ten degrees of freedom corresponding to the finite element model having one lakh degrees of freedom. In another example, the model builder 112 generates the reduced order model 124 having fifty degrees of freedom corresponding to the finite element model having three hundred thousand degrees of freedom. In a specific embodiment, the model builder 112 is configured to generate the plurality of reduced order models 124 having a plurality of model dimensions. In one embodiment, the model builder 112 is a software module stored in the memory 118 and executable by the at least one processor 116. In an alternate embodiment, the model builder 112 is a specialized hardware module configured to generate the reduced order model 124.

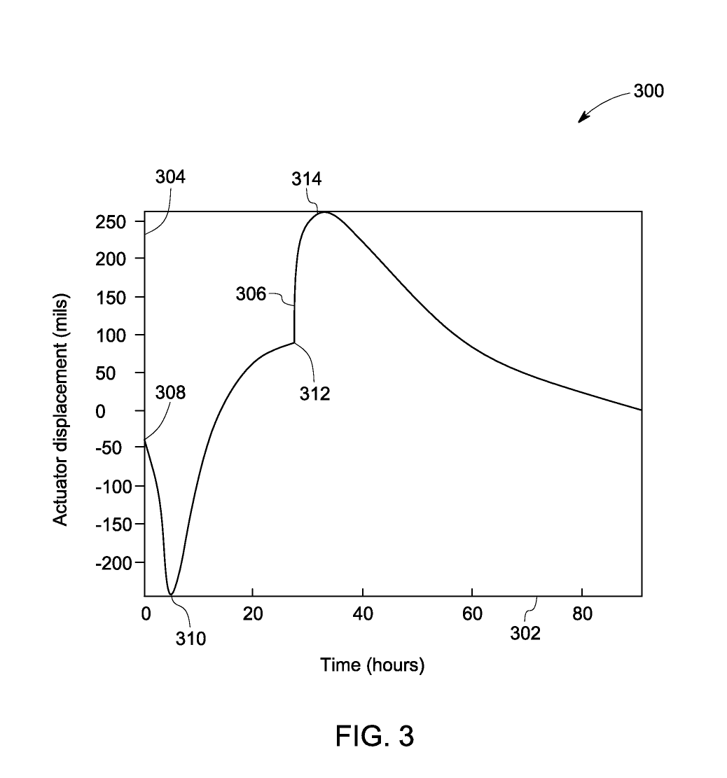

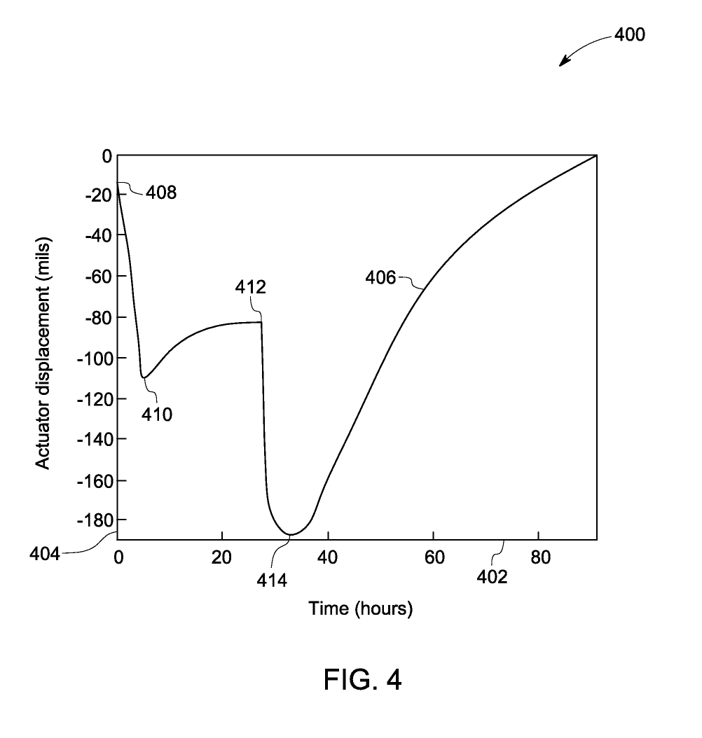

The clearance controller 114 is communicatively coupled to the model builder 112 and is configured to receive the plurality of measured operational parameters 108 from the sensor module 104. The clearance controller 114 is further configured to receive the reduced order model 124 generated by the model builder 112. In one embodiment, the clearance controller 114 is configured using a software to receive measured operational parameters 108. In another embodiment, the clearance controller 114 is configured to receive measured operational parameters 108 via an input port. The clearance controller 114 is configured to determine the estimated clearance 126 between the rotor 128 and the stator 130 of the turbo machine 102 based on the reduced order model 124 and the plurality of real-time operational parameters. In one embodiment, the clearance controller 114 is configured to generate a clearance profile (see e.g., FIG. 3-4) having a plurality of estimated clearances for a plurality of operating conditions of the turbo machine 102. Such a clearance profile is used to design an active clearance control mechanism for the turbo machine 102. During the operation of the turbo machine 102, the active clearance control mechanism is configured to maintain a measured clearance 132 based on the clearance profile, for a plurality of operating conditions throughout the operation cycle. The active clearance control mechanism may be controlled, based on the measured clearance 132 and the estimated clearance 126.

In one embodiment, the clearance profile may be modified based on the measured clearance 132 for a predefined operating condition of the turbo machine 102. In another embodiment, the measured clearance 132 is varied based on the estimated clearance 126. In an embodiment, the clearance controller 114 is a software module stored in the memory 118 and executable by the at least one processor 116. In an alternate embodiment, the clearance controller 114 is a specialized hardware module configured to generate the estimated clearance 126.

The at least one processor 116 of the system 100 is communicatively coupled to the finite element module 110, the model builder 112, the clearance controller 114, and the memory 118. The at least one processor 116 may include at least one arithmetic logic unit, microprocessor, general purpose controller or other processor arrays to perform the desired computations. In one embodiment, the functionality of the at least one processor 116 is limited to generating the plurality of snapshots 122. In another embodiment, the functionality of the at least one processor 116 includes building the reduced order model 124. In certain embodiments, the at least one processor 116 may be configured to perform functions of the clearance controller 114. In other embodiments, the at least one processor 116 may be configured to perform functions of the finite element module 110, the model builder 112, and the clearance controller 114. In other embodiments, other types of processors, operating systems, and physical configurations are also envisioned.

In one embodiment, the at least one processor 116 may include the memory 118. In another embodiment, the at least one processor 116 is communicatively coupled to the memory 118. The memory 118 may be a non-transitory storage medium. For example, the memory 118 may be a dynamic random access memory (DRAM) device, a static random access memory (SRAM) device, flash memory or other memory devices. In one embodiment, the memory 118 may include a non-volatile memory or similar permanent storage device, media such as a hard disk drive, a floppy disk drive, a compact disc read only memory (CD-ROM) device, a digital versatile disc read only memory (DVD-ROM) device, a digital versatile disc random access memory (DVD-RAM) device, a digital versatile disc rewritable (DVD-RW) device, a flash memory device, or other non-volatile storage devices. In one specific embodiment, a non-transitory computer readable medium may be encoded with a program to instruct the at least one processor 116 to estimate and control the measured clearance 132 between the rotor 128 and the stator 130 of the turbo machine 102.

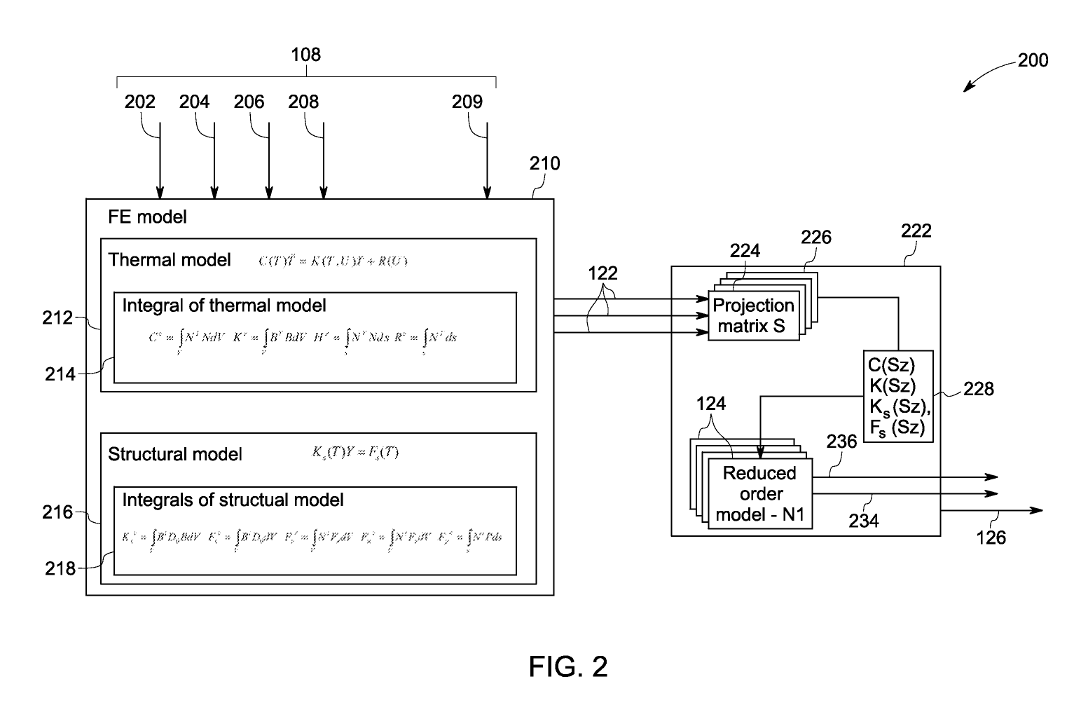

FIG. 2 is a flow diagram 200 illustrating the operation of the system 100 in accordance with an exemplary embodiment of FIG. 1. The plurality of measured operational parameters 108 are received by a finite element model 210. The plurality of measured operational parameters 108 may include the inlet pressure of the working fluid 202, the inlet temperature of the working fluid 204, the exhaust temperature 206, the mass flow of the working fluid 208, and the displacement 209 of the rotor 128. The finite element model 210 is represented by

C(T)\check{T}=K(T,U)T+R(U) (1)

Kₛ(T)Y=Fₛ(T) (2)

where equation (1) is representative of a thermal model 212 and equation (2) is representative of a structural model 216 of the finite element model 210. For the thermal model 212, C is representative of a thermal capacitance matrix, K is representative of a thermal conductivity matrix, R is representative of a load matrix, T is representative of nodal temperatures, U is representative of a vector of the plurality of measured operational parameters 108 and \check{T} is the derivative of the nodal temperatures. The thermal conductivity matrix K is representative of a function of the nodal temperatures T and the vector of the plurality of measured operational parameters U, the load matrix R is representative of a function of the vector of the plurality of the measured operational parameters U, and the thermal capacitance matrix C is representative of a function of the nodal temperatures T. For the structural model 216, Kₛ is representative of stiffness matrix, Fₛ is representative of a matrix of externally applied loads, and Y is representative of a displacement vector, and T is representative of nodal temperatures.

The plurality of snapshots 122 are generated by determining a plurality of element matrices for each element of the finite element model 210. In the illustrated embodiment, the thermal model 212 includes a plurality of element matrices C^{e}, K^{e}, H^{e}, R^{e} for each element of the finite element model 210. The plurality of element matrices C^{e}, K^{e}, H^{e}, R^{e} of the thermal model 212 are dependent on the material properties of the corresponding finite elements. When the material properties are set to unity, the plurality of element matrices are defined by:

$${C}^{e} = {\int }_{V}^{ } {N}^{t} N d V \\ {K}^{e} = {\int }_{V}^{ } {B}^{t} B d V \\ {H}^{e} = {\int }_{s}^{ } {N}^{t} N d s \\ {R}^{e} = {\int }_{s}^{ } {N}^{t} d s \qquad ( 3 )$$

where C^{e} is representative of the thermal capacitance matrix, K^{e} is representative of the thermal conductivity matrix, H^{e} is representative of convective temperature matrix, and R^{e} is representative of a thermal load matrix for an element of the finite element model 210. N is representative of an interpolation function, B is representative of a gradient of the interpolation function, V is representative of a volume of an element of the finite element model 210, s is representative of a surface area of an element of the finite element model 210, and t is representative of a transposition operator.

In the illustrated embodiment, the structural model 216 includes a plurality of element matrices K^{e}ₛ, F^{e}ₛ, F^{e}ᵣ, F^{e}_{w}, F^{e}ₚ. The plurality of element matrices K^{e}ₛ, F^{e}ₛ, F^{e}ᵣ, F^{e}_{w}, F^{e}ₚ of the structural model 216 are dependent on the material properties and the nodal temperatures. When the material properties and a plurality of temperature differences are set to unity, the plurality of element matrices of the structural model 216 are represented by:

$${K}_{s}^{e} = {\int }_{V}^{ } {B}^{t} {D}_{0} B d V \\ {F}_{s}^{e} = {\int }_{V}^{ } {B}^{t} {D}_{0} d V \\ {F}_{r}^{e} = {\int }_{V}^{ } {N}^{t} {F}_{r} d V \\ {F}_{w}^{e} = {\int }_{V}^{ } {N}^{t} {F}_{w} d V \\ {F}_{p}^{e} = {\int }_{s}^{ } {N}^{t} P d s \qquad ( 4 )$$

where K^{e}ₛ is representative of an element stiffness matrix corresponding to a predetermined material, F^{e}ₛ is representative of an element matrix due to nodal temperature, F^{e}ᵣ is representative of an element matrix of centrifugal force, F^{e}_{w} is representative of an element matrix of gravity force, and F^{e}ₚ is representative of an element matrix of pressure. D₀ is representative of a stiffness matrix of the material, N is representative of an interpolation function, B is representative of a gradient of the interpolation function. The term Fᵣ is representative of inertia body force, F_{w} is representative of gravity force, V is representative of volume, s is representative of element surface, and P is representative of distributed pressure and t is representative of the transposition operator. The plurality of temperature differences is referred to herein as a plurality of differences between the nodal temperatures and a reference temperature.

It should be noted herein that a plurality of integrals 214 represented by the equation (3) and a plurality of integrals 218 represented by the equation (4) are associated with the thermal model 212 and the structural model 216. The plurality of integrals 214, 218 are based on geometry of the turbo machine. The finite element module 110 (shown in FIG. 1), is configured to evaluate the plurality of integrals 214 of the thermal model 212 and the plurality of integrals 218 of the structural model 216. In an exemplary embodiment, the plurality of integrals 214, 218 may be modified based on the temperature dependent components of the finite element model 210. In another exemplary embodiment, the plurality of integrals 214, 218 may be modified based on the material properties. In one embodiment, the plurality of element matrices are approximated by replacing average material properties by nodal material properties. In another embodiment, the plurality of element matrices are approximated based on a linear model for material properties. In one embodiment, the structural model is normalized by temperature dependent Young's modulus enabling offline assembly and inversion of stiffness matrix.

It should be noted herein that some among the plurality of integrals 214, 218 may not considered for every application. For example, the term F^{e}ᵣ is not applicable for elements of a stator component. The term F^{e}ᵣ is used only for rotating parts such as a rotor, for example. In some embodiments, additional integrals representative of other force terms may be used. In other embodiments, some of the force terms represented by the plurality of integrals 214, 218 are omitted from the finite element model 210.

The finite element model 210 is configured to generate the plurality of snapshots 122 based on the plurality of element matrices of each element of the finite element model 210. The plurality of snapshots 122 include a plurality of nodal temperature values and a plurality of estimates of the displacement vector. The plurality of snapshots 122 is representative of a subset of the columns of a state matrix of the finite element model 210. A snapshot matrix, generated based on the plurality of snapshots 122, is represented by:

$$Φ = [ \begin{matrix}{T}_{1} ( 1 ) & … & {T}_{1} ( k ) \\ {T}_{2} ( 2 ) & … & {T}_{2} ( k ) \\ {T}_{3} ( 3 ) & … & {T}_{3} ( k ) \\ ⋮ & … & \\ {T}_{N} ( 1 ) & … & {T}_{N} ( k )\end{matrix} ] \qquad ( 5 )$$

where Tₙ(p) is representative of the p^{th} instance of the nth nodal temperature generated by the finite element model 210.

The flow diagram 200 further shows generation of the reduced order model 124 and computation of the estimated clearance 126 as represented by reference numeral 222. A projection matrix 224 is computed based on the plurality of snapshots 122 from the finite element model 210. Specifically, the projection matrix 224 is computed based on a proper orthogonal decomposition (POD) technique of the snapshot matrix. The proper orthogonal decomposition of the snapshot matrix Φ is represented by:

Φ=P^{t}ΣQ (6)

where P is representative of left singular vectors, Σ is a diagonal matrix of singular values, Q is representative of right singular vectors, and t represents matrix transposition operator. The projection matrix 224 is determined based on the proper orthogonal decomposition technique and is represented by:

S=[p₁p₂ . . . pᵣ] (7)

where p₁ is representative of a first column, p₂ is representative of a second column, and pᵣ is representative of a r^{th} column of the left singular matrix P, r is representative of number of columns in the projection matrix S. The projection from full order state T to a reduced order state z is represented by:

z=S^{t}T. (8)

Alternatively, T is substituted by Sz in the finite element model 210 of equation (1) to generate the reduced order model 124 as represented by:

C(Sz)\check{z}=K(Sz,U)Sz+R(U)

Kₛ(Sz)Y=Fₛ(Sz) (9)

where \check{z} is the derivative of the reduced order state z.

The reduced order model 124 is generated based on the projection matrix 224. Generating the reduced order model 124 involves generating a plurality of reduced order matrices C(Sz), K(Sz), Ks(Sz), and Fs(Sz) represented by the reference numeral 228. In one embodiment, the model builder 112 generates a plurality of projection matrices 226 having different number of columns. The plurality of reduced order models 124 having a plurality of dimensions are generated based on the plurality of projection matrices 226. It should be noted herein that a reduced order model generates an estimated clearance with lower accuracy and at a lower computational cost. A reduced order model having a higher dimension generates an estimated clearance with higher accuracy and at a higher computational cost. In the illustrated embodiment, a displacement vector 234 and the nodal temperature 236 are determined based on the plurality of real-time operational parameters and the reduced order model 124. In an exemplary embodiment, the displacement vector is generated during operation of the turbo machine. The estimated clearance 126 is determined based on the displacement vector 234. In an exemplary embodiment, the estimated clearance 126 is determined for each operating condition from the plurality of operating conditions of the turbo machine 102. A clearance profile having the plurality of estimated clearance values corresponding to the plurality of operating conditions of the turbo machine 102 is then generated.

In an exemplary embodiment a plurality of clearance profiles are generated for a plurality of operating conditions of the turbo machine 102. An active clearance control mechanism may then be designed for the turbo machine 102, based on the generated plurality of clearance profiles.

In one embodiment, the measured clearance 132 of the turbo machine is controlled based on the estimated clearance 126. In such an embodiment, the measured clearance 132 is compared with the estimated clearance 126 to generate a difference value. The difference value is indicative of a deviation of the measured clearance 132 from the estimated clearance 126. The difference value is then compared with a pre-determined threshold value. When the difference value is smaller than or equal to the pre-determined threshold value, the measured clearance 132 is not controlled. When the difference value is greater than the pre-determined threshold value, the measured clearance 132 is controlled.

FIG. 3 is a graph 300 illustrating an axial clearance profile in accordance with an exemplary embodiment. The x-axis 302 is representative of time in hours and the y-axis 304 is representative of actuation displacement of the rotor in mils. The graph 300 shows a curve 306 representative of a clearance profile for control of an axial clearance between the stator and the rotor in a turbo machine. The clearance profile curve 306 includes a start-up condition 308, a long rotor condition 310, a steady state condition 312, and a short rotor condition 314. In the illustrated embodiment, the rotor is moved axially towards a thrust bearing by about 200 mils, when the machine transitions from the start-up condition 308 to the long rotor condition 310. The rotor is moved along an axial direction away from the thrust bearing by about 350 mils, when the machine transitions from the long rotor condition 310 to the steady state condition 312. When the machine transitions from the steady state condition 312 to the short rotor condition 314, the rotor is further moved axially away from the thrust bearing by about 150 mils. When the machine is in the short rotor condition 314, the rotor is gradually adjusted axially towards the thrust bearing and the machine is cooled.

FIG. 4 is a graph 400 illustrating a radial clearance profile in accordance with an exemplary embodiment. The x-axis 402 is representative of time in hours and the y-axis 404 is representative of actuation displacement of the rotor in mils. The graph 400 includes a curve 406 representative of a clearance profile for design and control of a radial clearance between the stator and the rotor in the turbo machine. The clearance profile curve 406 includes a start-up condition 408, a long rotor condition 410, a steady state condition 412, and a short rotor condition 414. When the turbo machine transitions from the start-up condition 408 to the long rotor condition 410, the rotor is moved axially towards the thrust bearing by about 110 mils. When the machine transitions from the long rotor condition 410 to the steady state condition 412, the rotor is moved axially away from the thrust bearing by about 30 mils for reducing the clearance between the rotor and the stator. When the turbo machine is shut down, the machine transitions from the steady state condition 412 to the short rotor condition 414 and the rotor is axially moved towards the thrust bearing by about 120 mils. When the machine is in the short rotor condition 414, the rotor is gradually adjusted away from the thrust bearing and the machine is cooled.

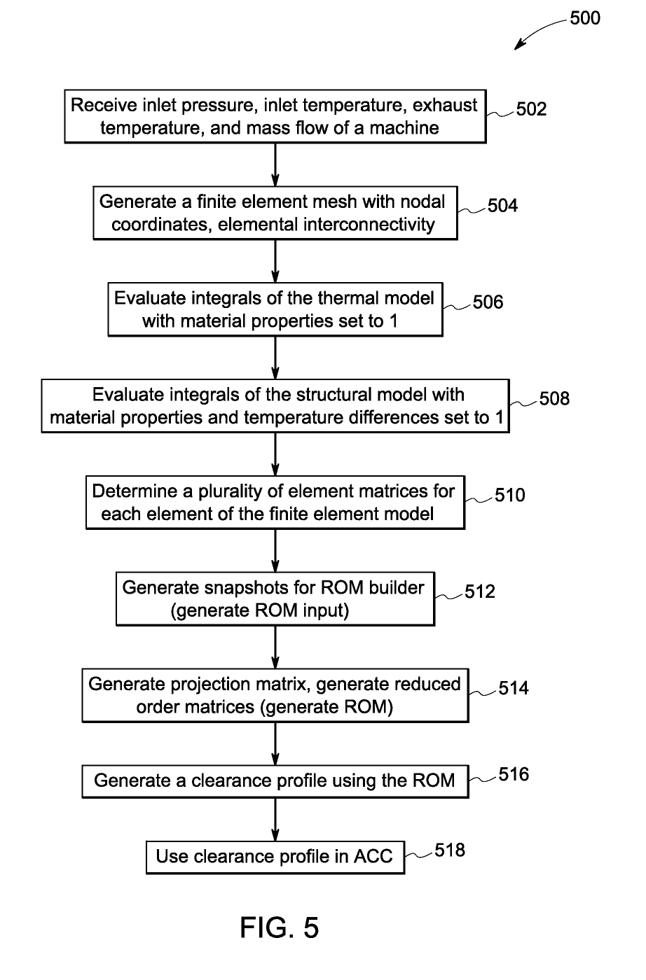

FIG. 5 illustrates a flow chart 500 representative of a method for estimating a clearance between a stator and a rotor in accordance with an exemplary embodiment. The method includes receiving a plurality of measured operational parameters of a turbo machine having a rotor and a stator. The plurality of measured operational parameters includes a plurality of real-time operational parameters and a plurality of stored operational parameters. The plurality of measured operational parameters may include an inlet pressure of the working fluid, an inlet temperature of the working fluid, an exhaust temperature of the working fluid, and a mass flow of the working fluid 502. A finite element model of the turbo machine is then generated. The finite element model includes a mesh having a plurality of elements represented by node co-ordinates coupled to each other via elemental connectors 504.

The finite element model includes a thermal model and a structural model. For the thermal model, the material properties of the finite element model are set to unity and a plurality of integrals are evaluated 506. For the structural model, the material properties and the plurality of temperature differences are set to unity and a plurality of integrals are evaluated 508. A plurality of element matrices of the finite element model are determined based on the plurality of integrals of the finite element model 510. A plurality of snapshots are generated 512 based on the finite element model and a plurality of measured operating conditions of the turbo machine.

A projection matrix is generated based on a plurality of snapshots. A reduced order model is generated 514 based on the projection matrix. A clearance profile is generated 516 based on the plurality of real-time operational parameters and the reduced order model. An active clearance control mechanism for the turbo machine 518 is designed based on the clearance profile.

Exemplary embodiments disclosed herein enable estimation and control of clearance in a turbo machine in real time. The exemplary technique involves use of a reduced order model requiring reduced computational requirements. Complexity is reduced by a factor of ten thousand with reference to a high fidelity finite element model. The exemplary reduced order model disclosed herein provides estimates of thermal and structural dynamics of the turbo machine having an accuracy in a range of 95% to 98% with reference to the high fidelity finite element model.

It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the specification is not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the specification may include only some of the described embodiments. Accordingly, the specification is not to be seen as limited by the foregoing description, but is only limited by the scope of the appended claims. What is claimed as new and desired to be protected by Letters Patent of the United States is:

1. A method comprising:
receiving a plurality of measured operational parameters of a turbo machine having a rotor and a stator, wherein the plurality of measured operational parameters comprises a plurality of real-time operational parameters and a plurality of stored operational parameters;
generating a finite element model of the turbo machine;
generating a plurality of snapshots based on the finite element model and the plurality of stored operational parameters;
generating a reduced order model based on the plurality of snapshots; and
determining an estimated clearance between the rotor and the stator during operation of the turbo machine, based on the reduced order model and the plurality of real-time operational parameters.

2. The method of claim 1, wherein generating the plurality of snapshots comprises determining a plurality of element matrices for each element of the finite element model.

3. The method of claim 2, wherein generating the plurality of snapshots further comprises evaluating a plurality of integrals of a thermal model of the finite element model, having a plurality of pre-defined material properties.

4. The method of claim 2, wherein generating the plurality of snapshots further comprises evaluating a plurality of integrals of a structural model of the finite element model, having a plurality of pre-defined material properties.

5. The method of claim 4, wherein the plurality of pre-defined material properties comprises a plurality of pre-defined temperature values.

6. The method of claim 1, wherein generating the reduced order model comprises generating a projection matrix.

7. The method of claim 6, wherein generating the reduced order model comprises generating a plurality of reduced order model matrices based on the projection matrix.

8. The method of claim 1, wherein the reduced order model comprises a plurality of reduced order models having a plurality of model dimensions.

9. The method of claim 1, wherein the estimated clearance comprises a clearance profile for a plurality of operating conditions of the turbo machine.

10. The method of claim 1, wherein the plurality of measured operational parameters comprises an inlet pressure, an inlet temperature, an exhaust temperature, a mass flow, and a measured clearance.

11. The method of claim 10, further comprising controlling the measured clearance based on the estimated clearance.

12. A system comprising:
at least one processor configured to receive a plurality of measured operational parameters of a turbo machine having a rotor and a stator, wherein the plurality of measured operational parameters comprises a plurality of real-time operational parameters and a plurality of stored operational parameters;
a finite element module communicatively coupled to the at least one processor and configured to:
generate a finite element model of the turbo machine; and
generate a plurality of snapshots based on the finite element model and the plurality of stored operational parameters;
a model builder communicatively coupled to the finite-element module and configured to generate a reduced order model based on the plurality of snapshots; and
a clearance controller communicatively coupled to the model builder and configured to determine an estimated clearance between the rotor and the stator during operation of the turbo machine, based on the reduced order model and the plurality of real-time operational parameters.

13. The system of claim 12, wherein the finite element model is further configured to generate the plurality of snapshots by determining a plurality of element matrices for each element of the finite element model.

14. The system of claim 13, wherein the finite element model is further configured to generate the plurality of snapshots by evaluating a plurality of integrals of a thermal model of the finite element model, having a plurality of pre-defined material properties.

15. The system of claim 13, wherein the finite element model is further configured to generate the plurality of snapshots by evaluating a plurality of integrals of a structural model of the finite element model, having a plurality of pre-defined material properties.

16. The system of claim 12, wherein the model builder is further configured to generate the reduced order model by generating a projection matrix.

17. The system of claim 16, wherein the model builder is further configured to generate a plurality of reduced order model matrices based on the projection matrix.

18. The system of claim 12, wherein the model builder is configured to generate the reduced order model comprising a plurality of reduced order models having a plurality of model dimensions.

19. The system of claim 12, wherein the clearance controller is further configured to determine the estimated clearance by generating a clearance profile for a plurality of operating conditions of the turbo machine.

20. The system of claim 12, wherein the plurality of measured operational parameters comprises an inlet pressure, an inlet temperature, an exhaust temperature, a mass flow, and a measured clearance.

21. The system of claim 20, wherein the clearance controller is further configured to control the measured clearance based on the estimated clearance.

22. A non-transitory encoded computer medium having instructions to enable at least one processor to:
receive a plurality of measured operational parameters of a turbo machine having a rotor and a stator, wherein the plurality of measured operational parameters comprises a plurality of real-time operational parameters and a plurality of stored operational parameters;
generate a finite element model of the turbo machine;
generate a plurality of snapshots based on the finite element model and the plurality of stored operational parameters;
generate a reduced order model based on the plurality of snapshots; and
determine an estimated clearance between the rotor and the stator during operation of the turbo machine, based on the reduced order model and the plurality of real-time operational parameters.
